(19) United States
(12) Patent Application Publication
(10) Pub. No.: US 2025/0063331 A1
(43) Pub. Date: Feb. 20, 2025

(54) METHODS FOR 5G MEDIA STREAMING PROVISIONING OF SERVICE

(71) Applicant: Tencent America LLC, Palo Alto, CA (US)

(72) Inventor: Iraj SODAGAR, Los Angeles, CA (US)

(73) Assignee: Tencent America LLC, Palo Alto, CA (US)

(21) Appl. No.: 18/804,857

(22) Filed: Aug. 14, 2024

Related U.S. Application Data
(60) Provisional application No. 63/547,514, filed on Nov. 6, 2023.
(60) Provisional application No. 63/547,513, filed on Nov. 6, 2023.
(60) Provisional application No. 63/547,508, filed on Nov. 6, 2023.
(60) Provisional application No. 63/547,506, filed on Nov. 6, 2023.
(60) Provisional application No. 63/533,316, filed on Aug. 17, 2023.

(51) Int. Cl. H04W 4/50; H04W 28/16

(52) U.S. Cl. CPC H04W 4/50; H04W 28/16

(57) ABSTRACT

There is included a method and apparatus comprising computer code configured to cause a processor or processors to receive a first service provisioning session request for devices of a first release; control a 5GMS Application Server to allocate resources for the requested first service provisioning session; receive a second service provisioning session request for devices of a second release; control the 5GMS Application Server to determine whether the allocated resources for the requested first service provisioning session are adequate for the requested second service provisioning session; and in response to determining that the allocated resources for the requested first service provisioning session are not adequate for the requested second service provisioning session, control the 5GMS Application Server to allocate resources for the requested second service provisioning session.

### CROSS REFERENCE TO RELATED APPLICATION

The present application claims priority to U.S. Provisional Application No. 63/533,316, filed on Aug. 17, 2023, and U.S. Provisional Application Nos. 63/547,506, 63/547,508, 63/547,513, 63/547,514, filed on Nov. 6, 2023, the contents of which are hereby expressly incorporated by reference, in their entireties, into the present application.

### BACKGROUND

### 1. Field

This disclosure relates to a media streaming service in a 5G network, including provisioning for devices of various releases, background data transfer in 5G networks with multiple time windows, providing the service access information and any changes occurring in the service access information efficiently to the devices on 5G networks, and/or using various global identifiers to connect various aspects of 5G media services with each other when different entities report their activities.

### 2. Description of Related Art

3GPP TS26.501 defines downlink and uplink media streaming architecture for 5G networks.

3GPP TS26.501 defines the service access information resource by which the network provides information about accessing media services to the device. The service access information includes several sub-resources that one or more may be used at the start of the service or may get updated or destroyed during the use of the service.

3GPP TS26.12 defines APIs for providing such a service and delivery of multimedia content in 5G networks, however, each release may use a new version number, and the services are provisioned for each version.

3GPP TS26.512 further defines the concept of background data transfer in which the data is transferred in a given time window in the day. However, the days can be repeated but the provisioning only allows the use of a single time window in a day.

3GPP TS26.512 further defines a set of APIs for the delivery of multimedia content in 5G networks. However, it does not provide a coherent mechanism to relate the services that might stop and start again or are interrupted. Furthermore, there is no mechanism to relate various network-based services that are used only for a duration of time for a service.

### SUMMARY

To address one or more different technical problems, this disclosure provides technical solutions to improve sharing computational and storage resources for efficient deployments; access different release resources by 5GMS Application Provider; improve ability of devices of each release to access to the appropriate resources using more detailed service access information; and exchange of streaming session ID between the network and the device so that the device may start and stop a streaming session under one provisioning session.

There is included a method and apparatus comprising memory configured to store computer program code and a processor or processors configured to access the computer program code and operate as instructed by the computer program code. The computer program code may cause the processor or processors to receive a first service provisioning session request for devices of a first release; control a 5GMS Application Server to allocate resources for the requested first service provisioning session; receive a second service provisioning session request for devices of a second release; control the 5GMS Application Server to determine whether the allocated resources for the requested first service provisioning session are adequate for the requested second service provisioning session; and in response to determining that the allocated resources for the requested first service provisioning session are not adequate for the requested second service provisioning session, control the 5GMS Application Server to allocate resources for the requested second service provisioning session.

There is included a method and apparatus comprising memory configured to store computer program code and a processor or processors configured to access the computer program code and operate as instructed by the computer program code. The computer program code may include controlling code configured to cause the at least one processor to control a 5GMS network device to provision resources using service access information, wherein: the service access information includes a plurality of sub-resources, and the service access information includes a change flag is associated with each of the plurality of sub-resources, the change flag indicates that a respective sub-resource associated with the change flag has been changed or is new, and when one or more change flags are set to true, the service access information further includes one or more additional data structures for one or more sub-resources associated with the one or more change flags.

There is included a method and apparatus comprising memory configured to store computer program code and a processor or processors configured to access the computer program code and operate as instructed by the computer program code. The computer program code may cause the processor or processors to control a 5GMS network device to provision resources using service access information, wherein: the service access information includes a plurality of sub-resources, and the service access information includes a change attribute is associated with each of the plurality of sub-resources, the change attribute indicates whether a respective sub-resource associated with the change attribute has been created, updated, destroyed, or not changed, and when one or more change attributes indicate that one or more sub-resources are created or updated, the service access information further includes one or more additional data structures for the one or more sub-resources associated with the one or more change attributes.

### BRIEF DESCRIPTION OF THE DRAWINGS

Further features, nature, and various advantages of the disclosed subject matter will be more apparent from the following detailed description and the accompanying drawings in which:

FIG. 1 is a simplified schematic illustration in accordance with embodiments.

FIG. 2 is a simplified schematic illustration in accordance with embodiments.

FIG. 3 is a simplified block diagram regarding decoders in accordance with embodiments.

FIG. 4 is a simplified block diagram regarding encoders in accordance with embodiments.

FIG. 5 is a simplified block diagram regarding 5GMS architecture in accordance with embodiments.

FIG. 6A-6B are simplified workflow diagrams regarding a process for linking provisioning sessions together in accordance with embodiments.

FIG. 7 is a simplified syntax illustration of a service access information resource in accordance with embodiments.

FIGS. 8A-8B are simplified syntax illustrations of a service access information resource in accordance with embodiments.

FIG. 9 is a simplified block diagram regarding lifetime and scope of session IDs in accordance with embodiments.

FIG. 10 is a simplified block diagram regarding a computer system in accordance with embodiments.

### DETAILED DESCRIPTION

The proposed features discussed below may be used separately or combined in any order. Further, the embodiments may be implemented by processing circuitry (e.g., one or more processors or one or more integrated circuits). In one example, the one or more processors execute a program that is stored in a non-transitory computer-readable medium.

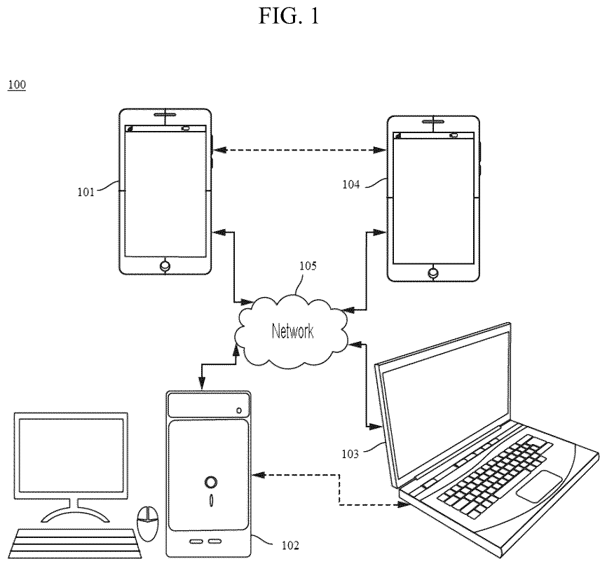

FIG. 1 illustrates a simplified block diagram of a communication system 100 according to an embodiment of the present disclosure. The communication system 100 may include at least two terminals 102 and 103 interconnected via a network 105. For unidirectional transmission of data, a first terminal 103 may code video data at a local location for transmission to the other terminal 102 via the network 105. The second terminal 102 may receive the coded video data of the other terminal from the network 105, decode the coded data and display the recovered video data. Unidirectional data transmission may be common in media serving applications and the like.

FIG. 1 illustrates a second pair of terminals 101 and 104 provided to support bidirectional transmission of coded video that may occur, for example, during videoconferencing. For bidirectional transmission of data, each terminal 101 and 104 may code video data captured at a local location for transmission to the other terminal via the network 105. Each terminal 101 and 104 also may receive the coded video data transmitted by the other terminal, may decode the coded data and may display the recovered video data at a local display device.

In FIG. 1, the terminals 101, 102, 103 and 104 may be illustrated as servers, personal computers and smart phones but the principles of the present disclosure are not so limited. Embodiments of the present disclosure find application with laptop computers, tablet computers, media players and/or dedicated video conferencing equipment. The network 105 represents any number of networks that convey coded video data among the terminals 101, 102, 103 and 104, including for example wireline and/or wireless communication networks. The communication network 105 may exchange data in circuit-switched and/or packet-switched channels. Representative networks include telecommunications networks, local area networks, wide area networks and/or the Internet. For the purposes of the present discussion, the architecture and topology of the network 105 may be immaterial to the operation of the present disclosure unless explained herein below.

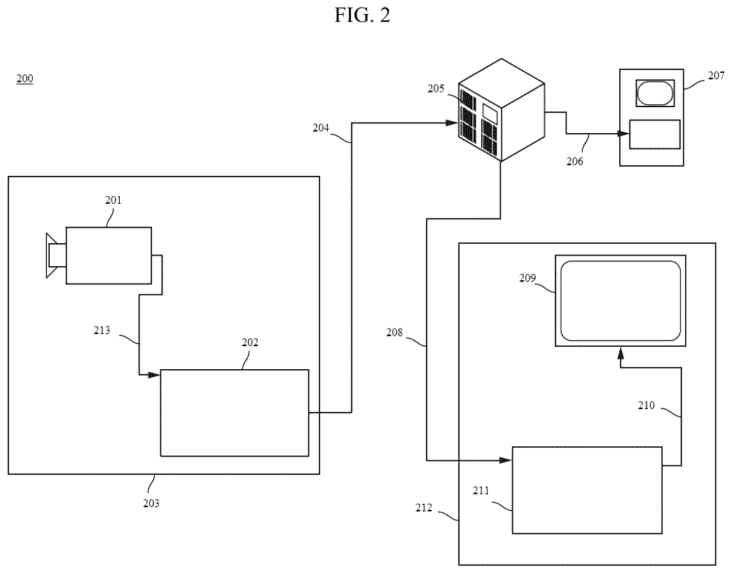

FIG. 2 illustrates, as an example for an application for the disclosed subject matter, the placement of a video encoder and decoder in a streaming environment. The disclosed subject matter can be equally applicable to other video enabled applications, including, for example, video conferencing, digital TV, storing of compressed video on digital media including CD, DVD, memory stick and the like, and so on.

A streaming system may include a capture subsystem 203, that can include a video source 201, for example a digital camera, creating, for example, an uncompressed video sample stream 213. That sample stream 213 may be emphasized as a high data volume when compared to encoded video bitstreams and can be processed by an encoder 202 coupled to the camera 201. The encoder 202 can include hardware, software, or a combination thereof to enable or implement aspects of the disclosed subject matter as described in more detail below. The encoded video bitstream 204, which may be emphasized as a lower data volume when compared to the sample stream, can be stored on a streaming server 205 for future use. One or more streaming clients 212 and 207 can access the streaming server 205 to retrieve copies 208 and 206 of the encoded video bitstream 204. A client 212 can include a video decoder 211 which decodes the incoming copy of the encoded video bitstream 208 and creates an outgoing video sample stream 210 that can be rendered on a display 209 or other rendering device (not depicted). In some streaming systems, the video bitstreams 204, 206 and 208 can be encoded according to certain video coding/compression standards. Examples of those standards are noted above and described further herein.

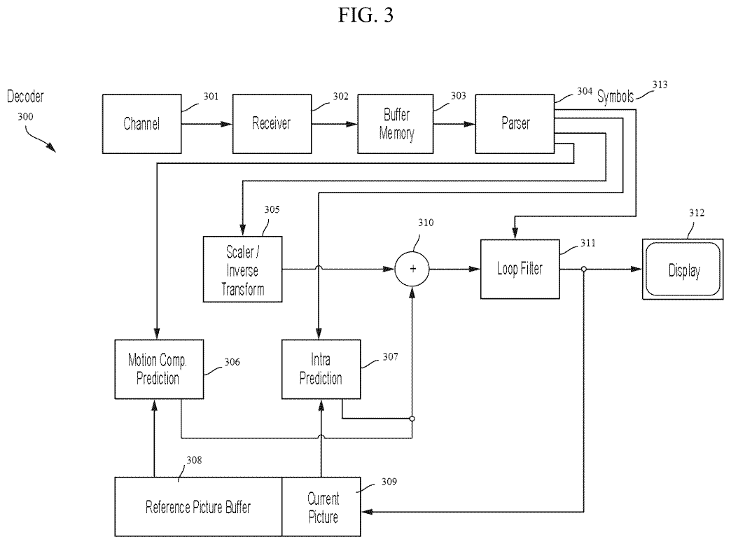

FIG. 3 may be a functional block diagram of a video decoder 300 according to an embodiment of the present invention.

A receiver 302 may receive one or more codec video sequences to be decoded by the decoder 300; in the same or another embodiment, one coded video sequence at a time, where the decoding of each coded video sequence is independent from other coded video sequences. The coded video sequence may be received from a channel 301, which may be a hardware/software link to a storage device which stores the encoded video data. The receiver 302 may receive the encoded video data with other data, for example, coded audio data and/or ancillary data streams, that may be forwarded to their respective using entities (not depicted). The receiver 302 may separate the coded video sequence from the other data. To combat network jitter, a buffer memory 303 may be coupled in between receiver 302 and entropy decoder/parser 304 (“parser” henceforth). When receiver 302 is receiving data from a store/forward device of sufficient bandwidth and controllability, or from an isosynchronous network, the buffer 303 may not be needed, or can be small. For use on best effort packet networks such as the Internet, the buffer 303 may be required, can be comparatively large and can advantageously of adaptive size.

The video decoder 300 may include a parser 304 to reconstruct symbols 313 from the entropy coded video sequence. Categories of those symbols include information used to manage operation of the decoder 300, and potentially information to control a rendering device such as a display 312 that is not an integral part of the decoder but can be coupled to it. The control information for the rendering device(s) may be in the form of Supplementary Enhancement Information (SEI messages) or Video Usability Information parameter set fragments (not depicted). The parser 304 may parse/entropy-decode the coded video sequence received. The coding of the coded video sequence can be in accordance with a video coding technology or standard, and can follow principles well known to a person skilled in the art, including variable length coding, Huffman coding, arithmetic coding with or without context sensitivity, and so forth. The parser 304 may extract from the coded video sequence, a set of subgroup parameters for at least one of the subgroups of pixels in the video decoder, based upon at least one parameters corresponding to the group. Subgroups can include Groups of Pictures (GOPs), pictures, tiles, slices, macroblocks, Coding Units (CUs), blocks, Transform Units (TUs), Prediction Units (PUs) and so forth. The entropy decoder/parser may also extract from the coded video sequence information such as transform coefficients, quantizer parameter values, motion vectors, and so forth.

The parser 304 may perform entropy decoding/parsing operation on the video sequence received from the buffer 303, so to create symbols 313. The parser 304 may receive encoded data, and selectively decode particular symbols 313. Further, the parser 304 may determine whether the particular symbols 313 are to be provided to a Motion Compensation Prediction unit 306, a scaler/inverse transform unit 305, an Intra Prediction Unit 307, or a loop filter 311.

Reconstruction of the symbols 313 can involve multiple different units depending on the type of the coded video picture or parts thereof (such as: inter and intra picture, inter and intra block), and other factors. Which units are involved, and how, can be controlled by the subgroup control information that was parsed from the coded video sequence by the parser 304. The flow of such subgroup control information between the parser 304 and the multiple units below is not depicted for clarity.

Beyond the functional blocks already mentioned, decoder 300 can be conceptually subdivided into a number of functional units as described below. In a practical implementation operating under commercial constraints, many of these units interact closely with each other and can, at least partly, be integrated into each other. However, for the purpose of describing the disclosed subject matter, the conceptual subdivision into the functional units below is appropriate.

A first unit is the scaler/inverse transform unit 305. The scaler/inverse transform unit 305 receives quantized transform coefficient as well as control information, including which transform to use, block size, quantization factor, quantization scaling matrices, etc. as symbol(s) 313 from the parser 304. It can output blocks comprising sample values, that can be input into aggregator 310.

In some cases, the output samples of the scaler/inverse transform 305 can pertain to an intra coded block; that is: a block that is not using predictive information from previously reconstructed pictures, but can use predictive information from previously reconstructed parts of the current picture. Such predictive information can be provided by an intra picture prediction unit 307. In some cases, the intra picture prediction unit 307 generates a block of the same size and shape of the block under reconstruction, using surrounding already reconstructed information fetched from the current (partly reconstructed) picture 309. The aggregator 310, in some cases, adds, on a per sample basis, the prediction information the intra prediction unit 307 has generated to the output sample information as provided by the scaler/inverse transform unit 305.

In other cases, the output samples of the scaler/inverse transform unit 305 can pertain to an inter coded, and potentially motion compensated block. In such a case, a Motion Compensation Prediction unit 306 can access reference picture memory 308 to fetch samples used for prediction. After motion compensating the fetched samples in accordance with the symbols 313 pertaining to the block, these samples can be added by the aggregator 310 to the output of the scaler/inverse transform unit (in this case called the residual samples or residual signal) so to generate output sample information. The addresses within the reference picture memory form where the motion compensation unit fetches prediction samples can be controlled by motion vectors, available to the motion compensation unit in the form of symbols 313 that can have, for example X, Y, and reference picture components. Motion compensation also can include interpolation of sample values as fetched from the reference picture memory when sub-sample exact motion vectors are in use, motion vector prediction mechanisms, and so forth.

The output samples of the aggregator 310 can be subject to various loop filtering techniques in the loop filter unit 311. Video compression technologies can include in-loop filter technologies that are controlled by parameters included in the coded video bitstream and made available to the loop filter unit 311 as symbols 313 from the parser 304, but can also be responsive to meta-information obtained during the decoding of previous (in decoding order) parts of the coded picture or coded video sequence, as well as responsive to previously reconstructed and loop-filtered sample values.

The output of the loop filter unit 311 can be a sample stream that can be output to the display 312, which may be a render device, as well as stored in the reference picture memory 557 for use in future inter-picture prediction.

Certain coded pictures, once fully reconstructed, can be used as reference pictures for future prediction. Once a coded picture is fully reconstructed and the coded picture has been identified as a reference picture (by, for example, parser 304), the current reference picture 309 can become part of the reference picture buffer 308, and a fresh current picture memory can be reallocated before commencing the reconstruction of the following coded picture.

The video decoder 300 may perform decoding operations according to a predetermined video compression technology that may be documented in a standard, such as ITU-T Rec. H.265. The coded video sequence may conform to a syntax specified by the video compression technology or standard being used, in the sense that it adheres to the syntax of the video compression technology or standard, as specified in the video compression technology document or standard and specifically in the profiles document therein. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an embodiment, the receiver 302 may receive additional (redundant) data with the encoded video. The additional data may be included as part of the coded video sequence(s). The additional data may be used by the video decoder 300 to properly decode the data and/or to more accurately reconstruct the original video data. Additional data can be in the form of, for example, temporal, spatial, or signal-to-noise ratio (SNR) enhancement layers, redundant slices, redundant pictures, forward error correction codes, and so on.

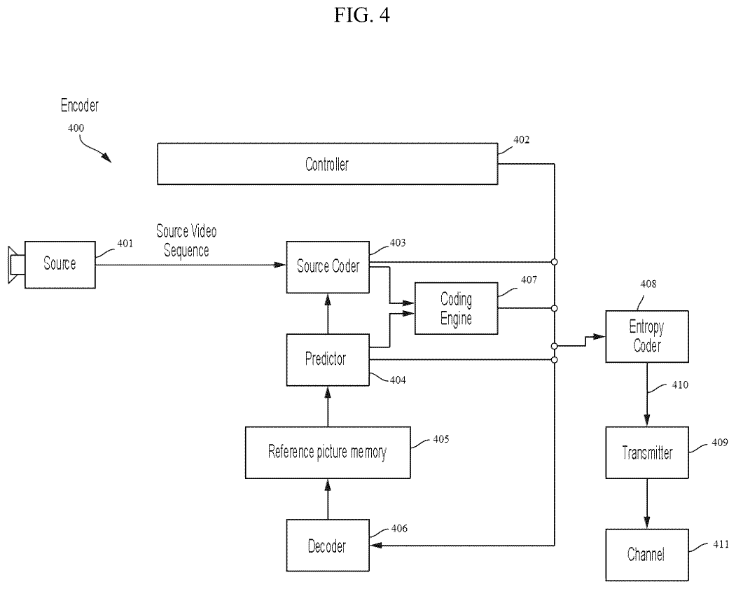

FIG. 4 may be a functional block diagram of a video encoder 400 according to an embodiment of the present disclosure.

The encoder 400 may receive video samples from a video source 401 (that is not part of the encoder) that may capture video image(s) to be coded by the encoder 400.

The video source 401 may provide the source video sequence to be coded by the encoder (303) in the form of a digital video sample stream that can be of any suitable bit depth (for example: 8 bit, 10 bit, 12 bit, . . . ), any colorspace (for example, BT.601 Y CrCB, RGB, . . . ) and any suitable sampling structure (for example Y CrCb 4:2:0, Y CrCb 4:4:4). In a media serving system, the video source 401 may be a storage device storing previously prepared video. In a videoconferencing system, the video source 401 may be a camera that captures local image information as a video sequence. Video data may be provided as a plurality of individual pictures that impart motion when viewed in sequence. The pictures themselves may be organized as a spatial array of pixels, wherein each pixel can comprise one or more samples depending on the sampling structure, color space, etc. in use. A person skilled in the art can readily understand the relationship between pixels and samples. The description below focuses on samples.

According to an embodiment, the encoder 400 may code and compress the pictures of the source video sequence into a coded video sequence 410 in real time or under any other time constraints as required by the application. Enforcing appropriate coding speed is one function of Controller 402. Controller controls other functional units as described below and is functionally coupled to these units. The coupling is not depicted for clarity. Parameters set by controller can include rate control related parameters (picture skip, quantizer, lambda value of rate-distortion optimization techniques, . . . ), picture size, group of pictures (GOP) layout, maximum motion vector search range, and so forth. A person skilled in the art can readily identify other functions of controller 402 as they may pertain to video encoder 400 optimized for a certain system design.

Some video encoders operate in what a person skilled in the art readily recognizes as a “coding loop.” As an oversimplified description, a coding loop can consist of the encoding part of an encoder (for example a source coder 403) (responsible for creating symbols based on an input picture to be coded, and a reference picture(s)), and a (local) decoder 406 embedded in the encoder 400 that reconstructs the symbols to create the sample data that a (remote) decoder also would create (as any compression between symbols and coded video bitstream is lossless in the video compression technologies considered in the disclosed subject matter). That reconstructed sample stream is input to the reference picture memory 405. As the decoding of a symbol stream leads to bit-exact results independent of decoder location (local or remote), the reference picture buffer content is also bit exact between local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is well known to a person skilled in the art.

The operation of the “local” decoder 406 can be the same as of a “remote” decoder 300, which has already been described in detail above in conjunction with FIG. 3. Briefly referring also to FIG. 4, however, as symbols are available and en/decoding of symbols to a coded video sequence by entropy coder 408 and parser 304 can be lossless, the entropy decoding parts of decoder 300, including channel 301, receiver 302, buffer 303, and parser 304 may not be fully implemented in local decoder 406.

An observation that can be made at this point is that any decoder technology except the parsing/entropy decoding that is present in a decoder also necessarily needs to be present, in substantially identical functional form, in a corresponding encoder. The description of encoder technologies can be abbreviated as they are the inverse of the comprehensively described decoder technologies. Only in certain areas a more detail description is required and provided below.

As part of its operation, the source coder 403 may perform motion compensated predictive coding, which codes an input frame predictively with reference to one or more previously-coded frames from the video sequence that were designated as “reference frames.” In this manner, the coding engine 407 codes differences between pixel blocks of an input frame and pixel blocks of reference frame(s) that may be selected as prediction reference(s) to the input frame.

The local video decoder 406 may decode coded video data of frames that may be designated as reference frames, based on symbols created by the source coder 403. Operations of the coding engine 407 may advantageously be lossy processes. When the coded video data may be decoded at a video decoder (not shown in FIG. 4), the reconstructed video sequence typically may be a replica of the source video sequence with some errors. The local video decoder 406 replicates decoding processes that may be performed by the video decoder on reference frames and may cause reconstructed reference frames to be stored in the reference picture memory 405, which may be for example a cache. In this manner, the encoder 400 may store copies of reconstructed reference frames locally that have common content as the reconstructed reference frames that will be obtained by a far-end video decoder (absent transmission errors).

The predictor 404 may perform prediction searches for the coding engine 407. That is, for a new frame to be coded, the predictor 404 may search the reference picture memory 405 for sample data (as candidate reference pixel blocks) or certain metadata such as reference picture motion vectors, block shapes, and so on, that may serve as an appropriate prediction reference for the new pictures. The predictor 404 may operate on a sample block-by-pixel block basis to find appropriate prediction references. In some cases, as determined by search results obtained by the predictor 404, an input picture may have prediction references drawn from multiple reference pictures stored in the reference picture memory 405.

The controller 402 may manage coding operations of the video coder 403, including, for example, setting of parameters and subgroup parameters used for encoding the video data. Output of all aforementioned functional units may be subjected to entropy coding in the entropy coder 408. The entropy coder translates the symbols as generated by the various functional units into a coded video sequence, by loss-less compressing the symbols according to technologies known to a person skilled in the art as, for example Huffman coding, variable length coding, arithmetic coding, and so forth.

The transmitter 409 may buffer the coded video sequence(s) as created by the entropy coder 408 to prepare it for transmission via a communication channel 411, which may be a hardware/software link to a storage device which would store the encoded video data. The transmitter 409 may merge coded video data from the video coder 403 with other data to be transmitted, for example, coded audio data and/or ancillary data streams (sources not shown).

The controller 402 may manage operation of the encoder 400. During coding, the controller 405 may assign to each coded picture a certain coded picture type, which may affect the coding techniques that may be applied to the respective picture. For example, pictures often may be assigned as one of the following frame types:

An Intra Picture (I picture) may be one that may be coded and decoded without using any other frame in the sequence as a source of prediction. Some video codecs allow for different types of Intra pictures, including, for example Independent Decoder Refresh Pictures. A person skilled in the art is aware of those variants of I pictures and their respective applications and features.

A Predictive picture (P picture) may be one that may be coded and decoded using intra prediction or inter prediction using at most one motion vector and reference index to predict the sample values of each block.

A Bi-directionally Predictive Picture (B Picture) may be one that may be coded and decoded using intra prediction or inter prediction using at most two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction).

Pixel blocks of P pictures may be coded non-predictively, via spatial prediction or via temporal prediction with reference to one previously coded reference pictures. Blocks of B pictures may be coded non-predictively, via spatial prediction or via temporal prediction with reference to one or two previously coded reference pictures.

The video coder 400 may perform coding operations according to a predetermined video coding technology or standard, such as ITU-T Rec. H.265. In its operation, the video coder 400 may perform various compression operations, including predictive coding operations that exploit temporal and spatial redundancies in the input video sequence. The coded video data, therefore, may conform to a syntax specified by the video coding technology or standard being used.

In an embodiment, the transmitter 409 may transmit additional data with the encoded video. The source coder 403 may include such data as part of the coded video sequence. Additional data may comprise temporal/spatial/SNR enhancement layers, other forms of redundant data such as redundant pictures and slices, Supplementary Enhancement Information (SEI) messages, Visual Usability Information (VUI) parameter set fragments, and so on.

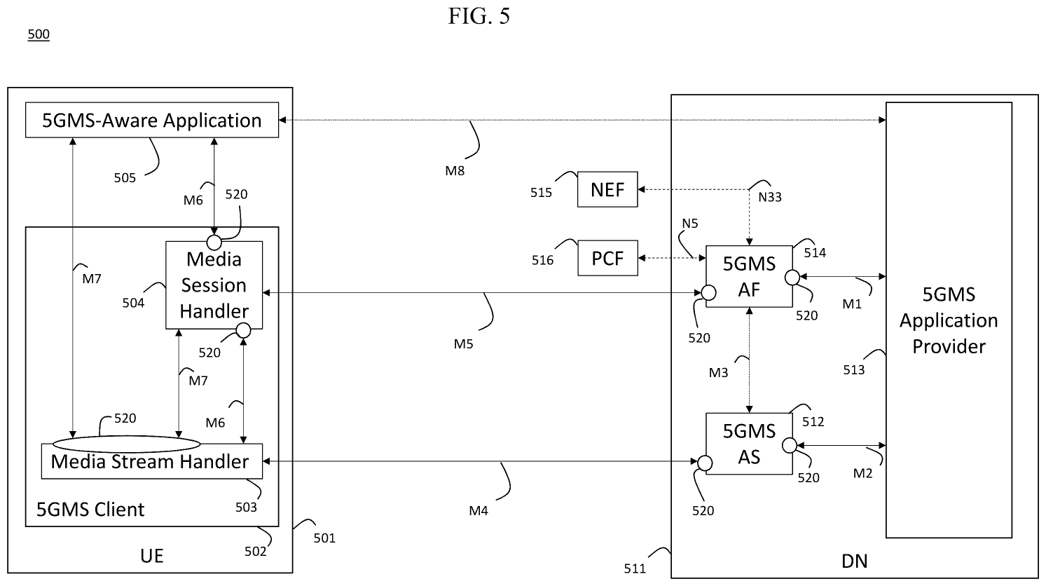

FIG. 5 illustrates block diagram 500 showing a 5G media streaming architecture with edge extensions according to exemplary embodiments. As shown, there is a user equipment (UE) 501 and a data network (DN) 511. The UE 501 may include a 5GMS client 502 and a 5GMS-aware application 505, such as the AR or non-AR embodiments described above those such applications are not limited thereto. The 5GMS client 502 may also include a media stream handler 503 and a media session handler. The DN 511 may include a 5GMS application server (AS) 512, a 5GMS application function (AF) 514, and a 5GMS application provider 513. The 5GMS AF 514 may also be in communication with a network exposure function (NEF) 515 and policy and charging function (PCF) 516. Improvements described herein may be understood in the context of at least any one or more of the UE 501, 5GMS aware application 505, 5GMS application provider 513, the NEF 515 and the PCF 516; that is, rather than having a monolithic specification that is absent definitions of the media service enabler (MSE) for each function or group of function, one or more of those elements may generate its own specification and, upon a conforming request provide such specification to another of those elements which may in turn further configure that initial elements specification depending on various possibilities such as those described further below, and such processing may be through any one or more of the shown multiple exposed application programming interfaces (APIs) 520 and interfaces M1, M2, M4, M5, M6, M7, M8, N33, and N5.

Embodiments of the present disclosure are directed to provisioning services, such that the same services can be used by devices of different releases.

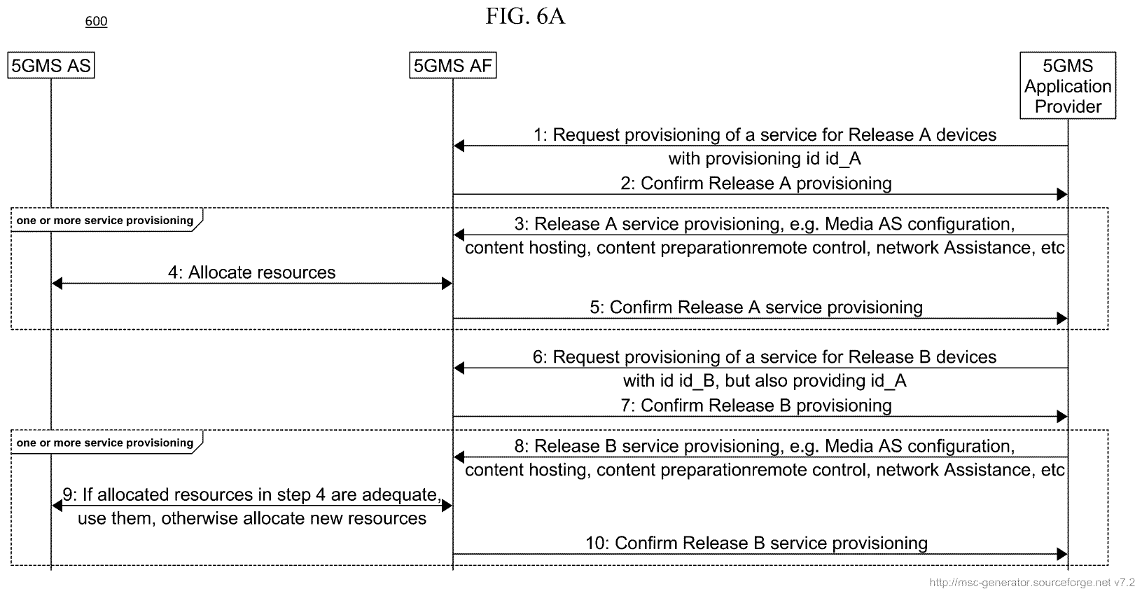

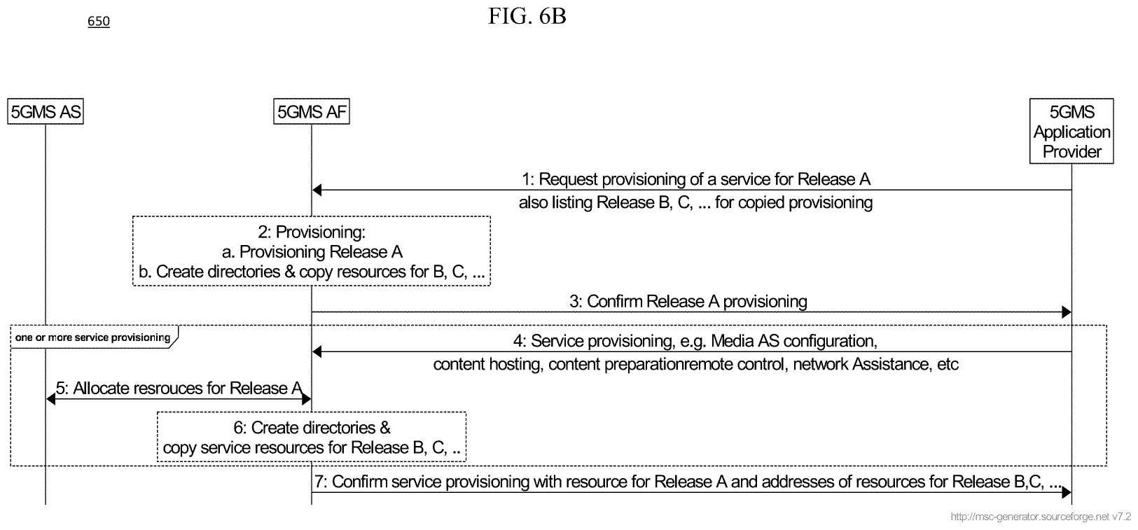

In one embodiment, a 5GMS Application Service Provider may provision the service for each release separately. Then, after provisioning the service for the first service, the 5GMS Service Provider provides its provisioning session ID during the provisioning of the service for devices with other releases as is shown in FIG. 6A.

According to an embodiment, a workflow 600, first a provisioning session is requested for the release A devices. Then, the services for that provisioning session are requested. When the provisioning session for release B devices is requested, the provisioning session ID of the release A devices is also provided by the 5GMS Application Function (AF). The 5GMS AF uses that session ID to identify the allocated resources in operation 4. If those resources are adequate for provisioning service of release B devices, then the 5GMS AF uses them. Otherwise, the 5GMS AF allocates new resources.

Using this approach, the provisioning resources between release A devices and release B devices are shared. Therefore the mobile network does not need to allocate two sets of resources and/or run two media streaming provisioning sessions in parallel.

In another embodiment, that is shown in FIG. 6B, first, the services for the latest release devices are provisioned. At the same provisioning session and in the same resource, the 5GMS Application Provider (AP) also requests the same services to be provisioned for other lower-level releases by listing them. Then the 5GMS AF first provisions the services for the latest release. The 5GMS AF also creates copies of the resource according to the lower requested releases and puts the corresponding resource conforming to each release in the appropriate location, then, the 5GMS AF confirms the 5GMS Application Service Provider (AS) with the resource location of the latest release as well as the addresses for the similar resources for the lower releases. If the 5GMS Application Provider wants to access the allocated resources for a lower release, it uses the corresponding address. It can provide information through M8 to the devices conforming to that release. Also since the 5GMS AF generates the copies of resources for lower releases, it stores those copies in the relevant addresses, so the lower release devices can download service access information through M5.

As is shown in the FIG. 6B, the 5GMS AF creates the relevant directories and copies the resources that are generated for the highest release (marked as Release A in the figure) to resources for other releases, reformatting and repurposing the fields, since the resource format may vary from a release to another release. Finally, the 5GMS AF confirms the provisioning by listing the resource for the highest release, and also provides the address for each corresponding resource of a lower release. Accordingly, the 5GMS Application Service Provider has information about all allocated resources for all releases.

An advantage of the present disclosure is that the provisioning of various releases is performed using the same resources, the mobile network uses the same computational and storage resources for all releases and doesn't have to duplicate resources. Therefore, it provides for more efficient deployments. Because the 5GMS Application Provider can retrieve the provisioning resources of all releases, it can communicate the corresponding the device's 5GMS Aware application with the corresponding resource. Further, since the service access information for all releases is created, the corresponding devices of each release have access to the appropriate service access information resource and can down it through M5.

According to embodiments, the 5GMS Service Provider can delete or purge each service for the release. But the deletion or purge of any resource does not result in removing resources unless it is the resource of the last release. In some embodiments, the 5GMS Application Provider only has access to retrieve the lower-level releases resources but it cannot update, delete or purge them.

According to an embodiment of the present disclosure, a method may include provisioning media streaming services on 5G for devices of different releases, wherein the provisioning resource, service provisioning resources and service access information resource, and where these resources are stored, are different for each release, wherein in the first method, a provision session identifier of previously provisioned released is shared during the request for the provisioning of the next release, and if resources that are previously allocated to previous release, can address the current release, the same will be used, wherein while each release has its own provisioning session, the mobile network is using the same computational, storage and bandwidth resources for all sessions.

According to an embodiment of the present disclosure, a method may include performing provisioning for the highest release first, and subsequently the 5GMS AF creating relevant directories, and corresponding mirror resources for the lower level releases from the highest release resource, copying the relevant information into the right format for each release, wherein in both methods, the service access information for each release is accessible through M5 and via the corresponding directory, where both methods result in efficient use of computational, bandwidth and storage resources of mobile network operators.

According to an embodiment, a method for background data transfer in 5G networks with multiple time windows may be provided. It improves the existing design by allowing multiple timed windows for the transfer of the data in a day with destTimeInt, as shown in Table 1, and recTimeInt, as shown in Table 2, being an array rather than a single element.

TABLE 1
Definition of M1BDTSpecification type

| Property | | | |
|---|---|---|---|
| name | Type | Cardinality | Description |
| bdtPolicyId | BdtReferenceId | 0 . . . 1 | If a BDT policy already exists, the policy |
| | | | identifier. The BdtReferenceId is defined in |
| | | | TS29.154. |
| desTimeInt | TimeWindow | 0 . . . N | The desired time window(s) for the |
| | | | activation of the BDT policy. |
| periodicity | Periodicity | 0 . . . 1 | The periodicity of the BDT policy. All |
| | | | repetitions have the same start and end time |
| | | | but a different date. |
| numOfUes | integer | 0 . . . 1 | The expected number of UEs that will use |
| | | | the BDT policy. |
| volPerUe | UsageThreshold | 0 . . . 1 | The expected usage threshold per UE when |
| | | | applying this BDT policy per day. |

NOTE 1:
Either bdtPolicyId is present or all other properties are present. In the latter case, the 5GMS AF will attempt to create a new BDT policy using the BDTPolicyControl_Create procedure as defined in TS29.554.
NOTE 2:
Datatype TimeWindow is defined in TS 24.558 [1].

TABLE 2
Definition of M5BDTSpecification type

| Property name | Type | Cardinality | Description |
|---|---|---|---|
| recTimeInt | TimeWindow | 1 . . . N | Indicates the recommended time interval(s) |
| | | | for using the BDT policy. |
| periodicity | Periodicity | 0 . . . 1 | The periodicity of the BDT window. All |
| | | | repetitions have the same start and end time |
| | | | but a different date. |
| maxBitRateDl | Bitrate | 0 . . . 1 | The maximum BDT bitrate in the downlink |
| | | | direction authorized for this UE. |
| maxBitrateUl | Bitrate | 0 . . . 1 | The maximum BDT bitrate in the uplink |
| | | | direction authorized for this UE. |
| estimatedVolume | UsageThreshold | 0 . . . 1 | The estimated data traffic that the UE is |
| | | | expected to use during the current time |
| | | | window. This value is provided by the MSH |
| | | | to the 5GMS AF. |

NOTE 1:
Datatype TimeWindow is defined in TS 24.558 [1].

According to an embodiment, volPerUe is used as an indicator of the volume of data used by a UE in all windows per day. The network can use this number and for each device, provides the maximum bitrate over the total number of times that the recTimeInt windows provided per day:

$$Max BitRateDI = min ( α \frac{volPerUe}{\sum recTimeInt ( duration )} , max AvailableDownloadBitrate ) \qquad Eqn ( 1 )$$

Where recTimeInt (duration) is the duration of one time window in seconds and a is a factor chosen by the network. If not many devices are active in the network, this factor can be bigger than 1. If the number of devices in the network is expected to exceed numOfUes, then this factor is set smaller than 1. The maxAvailableDownloadBitrate defines the maximum available download bitrate on the network for that device.

The uplink rate is calculated as:

$$Max BitRateUI = min ( β \frac{volPerUe}{\sum recTimeInt ( duration )} , max AvailableUplinkBitrate ) \qquad Eqn ( 2 )$$

Where β is a similar factor as a but just for uplink streaming and maxAvailableUplinkBitrate is the maximum available uplink streaming bitrate for the device in the network.

The device may return estimated Volume to the network to indicate the amount of data it will use for the current timed window. In embodiments of the disclosure, the device may use the following values to set the value:

$$stimatedVolume = \{ \begin{matrix}max BitRateDI * recTimeInt ( duration ) & for download \\ max BitRateUI * recTimeInt ( duration ) & for upload\end{matrix} \qquad Eqn ( 3 )$$

According to an embodiment, the device can use multiple windows to download/upload media content. The content may consist of multiple segments each of which has one URL or a common URL with a byte range. The device may keep track of downloaded/uploaded segments in each timed window and follow them with downloading/uploading the next segments when the next window becomes available. This way, the application can use multiple windows for background data transfer.

According to an embodiment, a method for background data transfer in 5GM media streaming architecture for downloading/uploading media streams is provided where multiple windows in one day are used for transfer, and the provisioning of background data transfer defines these multiple windows, and a device in the network can use these multiple windows to download/upload a content in sequence of pieces, each piece in one window.

According to an embodiment, this disclosure relates to providing service access information and any changes occurring in the service access information efficiently to the devices on 5G networks.

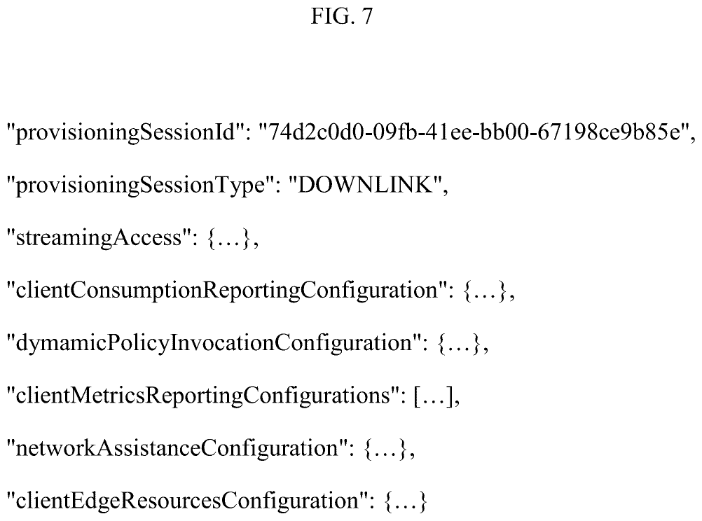

FIG. 7 shows an example of service access information resource to be provided to the device on the M3 interface as a single resource.

As shown in FIG. 7 in syntax 700, all sub-resources exist in the service access information. Whenever a sub-resource is updated, the other resources need to be included and therefore this approach creates an inefficient method of updating service access information since the unchanged resources need to be included. Furthermore, since the device receives complete service access information, it has to go through each sub-resource to check if that resource has been changed or not and if it does, then the device needs to take action.

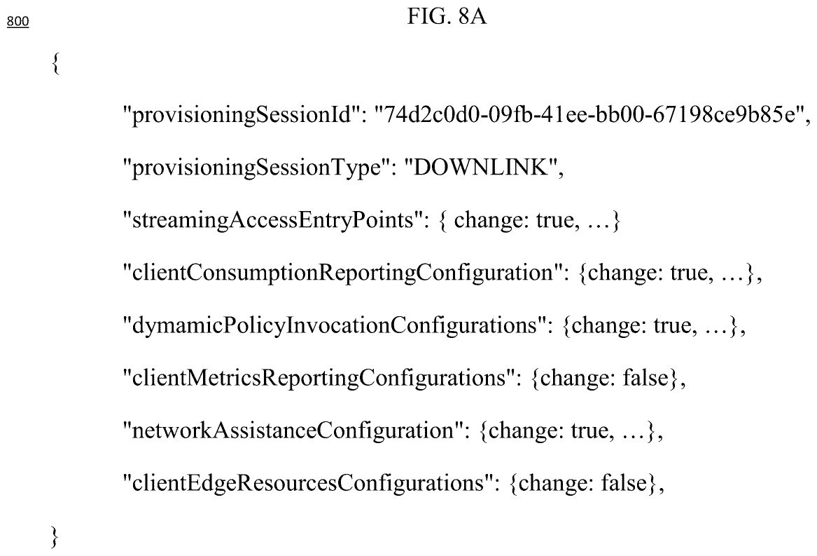

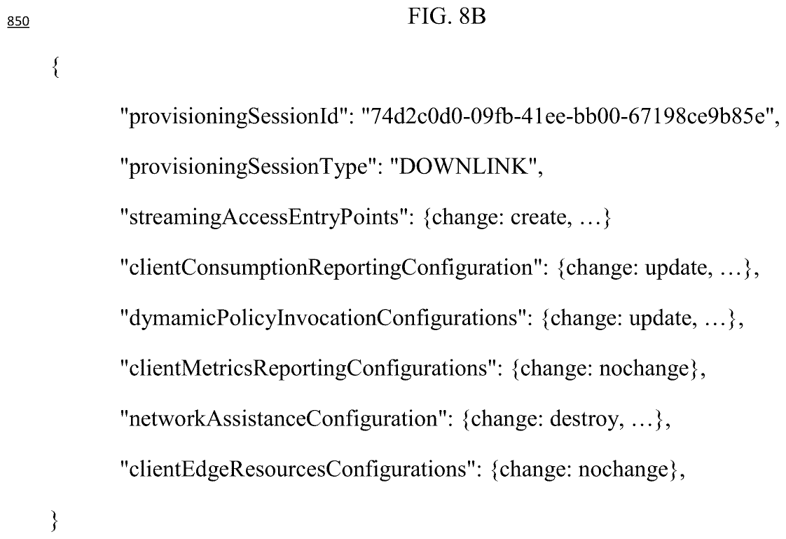

FIG. 8A shows an example of service access information resource to be provided to the device on the M3 interface as a single resource using a change flag.

According to an embodiment, a change flag for each sub-resource in the service access information may be added to the service access information resource. The change flag indicates whether the sub-resource has been updated or not, and if the flag is set to true, then an updated sub-resource is also included in service access information as shown in the syntax 800 as shown in FIG. 8A.

As shown in FIG. 8A, the following sub-resources are not changed, and their corresponding change flags are set to false, and no additional data is provided:
clientMetricsReportingConfigurations, clientEdgeResourcesConfigurations
while other resources are changed and therefore their updates are included.

In an embodiment, when the service access information is created for the first time, all the sub-resources are new. Therefore, all of their change flags are set to True and each resource contains its data structure.

In an embodiment, when a resource that didn't exist before is added to an existing service access information, only that resource has a change flag of True and the data structure of the sub-resource. All other resources have change flags set to false and no data are included.

In an embodiment, when a resource is updated, only that resource has a change flag of True and the data structure of the sub-resource. All other resources have change flags set to false and no data are included.

In an embodiment, when a resource is destroyed, only that resource has a change flag of True and the data structure of the sub-resource is also removed. All other resources have change flags set to false and no data are included.

The device may use the new service access information as the following:

The device downloads the service access information with a conditional HTTP GET: If empty, then no change in service access information; and if exists, the device goes through the change flags.

If there is a change, the device goes through the change flags. There should be at least one change flag with the value True, and for every change=True, whether the sub-resource existed before is checked.

If a sub-resource has not existed before, it's a new sub-resource, and the process to create and save the resource is started and/or performed.

If a sub-resource has existed before, the changes in the resource is found. If the sub-resource is empty, action is taken to remove the process and remove the previous sub-resource.

If the sub-resource is updated, the change is found, the appropriate action is undertaken and resource is updated.

According to an embodiment, the change flag may be implicitly signalled: if a sub-resource is included in the service access information, it has an update and if it is not included, it is either not defined (if it was not previously not defined, or it is not changed).

Accordingly, method for efficient delivery of service access information to create, update, and destroy is provided, wherein each sub-resource of the service access information has an explicit change flag, wherein a change flag value of false means that the resource has not been changed and no action is necessary, while a change flag value of truth means that if the sub-resource didn't exist, it has been created if it existed before, it has been updated, and if it existed before and it is empty now, it has been destroyed. In embodiments, instead of an explicit change flag, the existence of a resource means that it has been changed and needs to be updated.

FIG. 8B shows an example of service access information resource to be provided to the device on the M3 interface as a single resource using a change attribute.

According to an embodiment, a change attribute for each sub-resource in the service access information may be added to the service access information resource. The change attribute indicates whether the sub-resource has been created, updated, destroyed, or nochange, and if the attribute is set to anything but nochange, then an updated sub-resource is also included in service access information as shown in the syntax 800 as shown in FIG. 8A.

As shown in FIG. 8A, the following sub-resources are not changed, and no additional data is provided:
clientMetricsReportingConfigurations, clientEdgeResourcesConfigurations

The following sub-resource is created and has its data and/or data structure:
streamingAccessEntryPoints

The following subresources are updated and have their data and/or data structure:
clientConsumptionReportingConfiguration, dymamicPolicyInvocationConfigurations

And finally, the following subresource is destroyed and has no data:
networkAssistanceConfiguration

As indicated, the change attribute can have one of the following values:
1. Nochange: When the subresource is not changed.
2. Create: when a new subresource is provided for the first time
3. Update: when a subresource being updated
4. Destroy: when a subresource is removed

The advantage of such an attribute is that for each sub-resource it provides a status explicitly, and the device can use the explicit signalling to start a process for creating, updating, or destroying a sub-resource. The other benefit is that one single service access information request provides the latest status of all the sub-resources and there is no need for multiple requests

The device may use the new service access information as the following:

The device downloads the service access information with a conditional HTTP GET: If empty, then no change in service access information; and if exists, the device goes through the change flags.

If there is a change, the device goes through the change attributes. There should be at least one change attribute with a value other than nochange, and for every change, the following checks are conducted.

If change=create, check if the sub-resource existed before. If it does, it is an error, otherwise, create the corresponding process and save the sub-resource.

If change=update, check if the sub-resource existed before. If it doesn't, it is an error, otherwise, update the corresponding process and update the previously saved sub-resource with the new one.

If change=destroy, check if the sub-resource existed before. If it doesn't, it is an error, otherwise, destroy the corresponding process and delete the previously saved sub-resources.

Accordingly, method for efficient delivery of service access information to create, update, and destroy is provided, wherein each sub-resource of the service access information has a change attribute, wherein the attribute value of nochange means that the resource has not been changed and no action is necessary, while the attribute values of create, update and destroy mean the sub-resource is created, updated and destroyed respectively.

As stated above, 3GPP TS26.512 identifies a provisioning session with a session ID. All provisioning services are provisioning under that specific identifier through M1.

The service access information is also accessed through M5 using that provisioning session ID:
{apiRoot}/3gpp-m5/{apiVersion}/service-access-information/{provisioningSessionId}

According to an embodiment, an external service identifier which is defined by the Application service provider and the 5G AF may assign a provisioning session identifier to each external service identifier. A device may start and stop a streaming session under one provisioning session and right now the TS26.512 does not provide any distinction between the streaming sessions. Furthermore, the network may start and stop network services for processing media under one provisioning session and there is no separate identification of those services.

According to an embodiment, a delivery session ID that is unique to each media streaming session may be defined. Each time that device starts a new streaming session, a new identifier is assigned, and this way various streaming sessions are identified from each other.

According to an embodiment, a service session ID that is unique to each media service instance running on the 5G application server (AS) may be provided. Each time that the network starts a new service instance, a new identifier is assigned and this way various service instances are identified from each other, even if they are the same service.

Since each entity in the 5GMS architecture may be used for reporting the activities, having the relevant identifiers in that entity is essential to relate the various aspects of activities to each other in the report collection services.

TABLE 3
Available Identifiers in each 5GM entity

| | | Provi- | | | Delivery |
|---|---|---|---|---|---|
| | External | sioning | Service | Media | Session |
| | Service id | Session id | Session id | Delivery | ID |
| | (ESI) | (PSI) | (SSI) | ID (MDI) | (DSI) |
| ASP | X | X | | | |
| AF | X | X | X | X | X |
| AS | X | | X | | |
| Application | X | | | X | |
| MSH | X | | | X | X |
| MAF | X | | | | X |

Media Delivery ID (MDI) is an identifier for the device/application on the device using the provisioning session. It is used to identify the device/application uniquely.

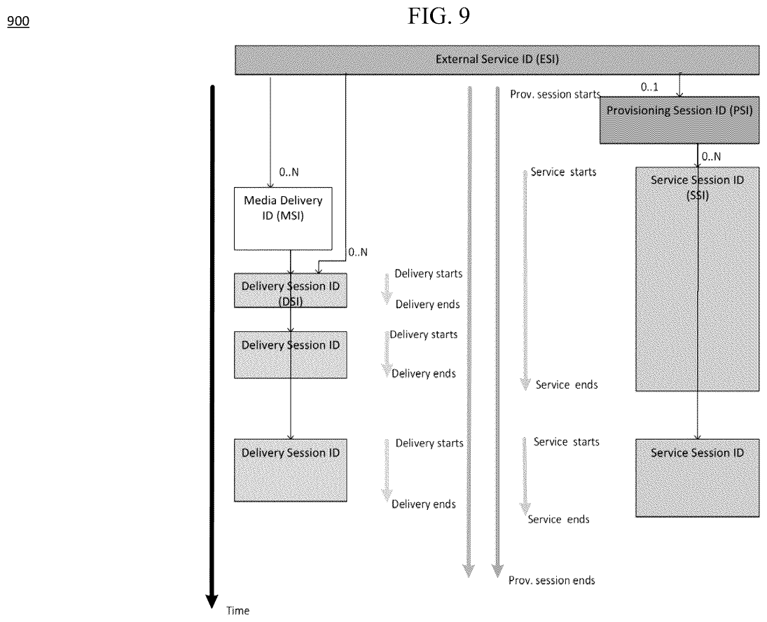

The lifetime of identifiers and uniqueness of them are defined in FIG. 9.

As shown in diagram 900, the application service provider provides the globally unique ESI to AF. Then, the AF assigns a network-unique provisioning session ID (PSI). Whenever, the AF starts a service in AS, it assigns the unique service session ID which is unique in AF. Then, the application service provider provides ESI to the application on the device.

The application and device assign a media delivery ID (MDI) that is unique for the application/service provider, and whenever the media session handler wants to deliver media, it provides ESI and MDI to start a media delivery session. It gets a delivery session ID (DSI) which is unique for the provisioning session.

The lifetime of each identifier is: ESI is globally unique; PSI exists during the provisioning session; MDI is defined as unique based on application/application provider needs; SSI is unique in PSI and exists with each service session; and DSI is unique in PSI and exists with each media delivery session.

The entities include the following identifiers in their reports: AF reports ESI and PSI; AS reports ESI/PSI and SSIs; and MAF reports ESI/PSI and DSIs.

Accordingly, a method for reporting various activities in the media streaming sessions in 5G networks is provided. Each entity uses specific combination of identifiers to identify the session in its reports wherein each identifier has a scope and a lifetime, defined such that the combination of identifiers reported by different entities provide adequate information about the session and services running under same provisioning service, such that the performance and characteristics of different entities in the service can be related with each other and enables a complete picture of the streaming session.

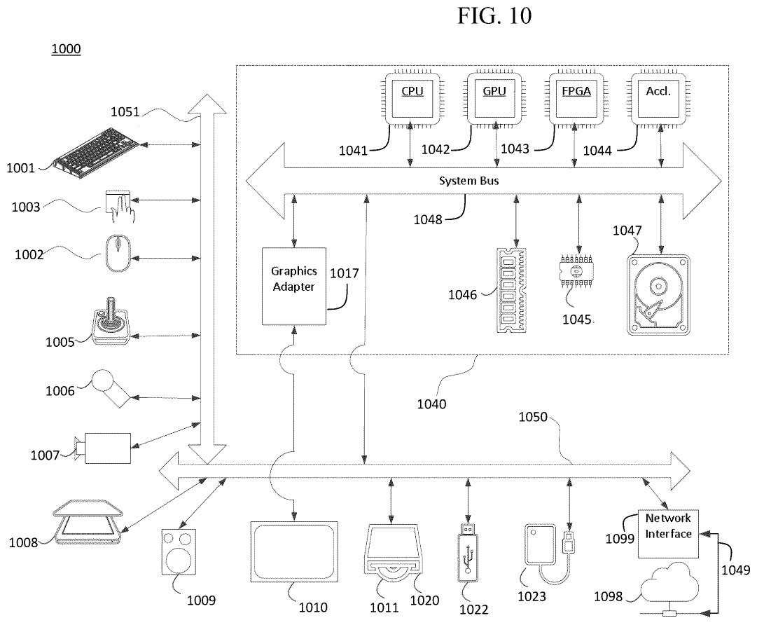

The techniques described above, can be implemented as computer software using computer-readable instructions and physically stored in one or more computer-readable media or by a specifically configured one or more hardware processors. For example, FIG. 10 shows a computer system 1000 suitable for implementing certain embodiments of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 10 for computer system 1000 are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system 1000.

Computer system 1000 may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard 1001, mouse 1002, trackpad 1003, touch screen 1010, joystick 1005, microphone 1006, scanner 1008, camera 1007.

Computer system 1000 may also include certain human interface output devices. Such human interface output devices may be stimulating the senses of one or more human users through, for example, tactile output, sound, light, and smell/taste. Such human interface output devices may include tactile output devices (for example tactile feedback by the touch-screen 1010, or joystick 1005, but there can also be tactile feedback devices that do not serve as input devices), audio output devices (such as: speakers 1009, headphones (not depicted)), visual output devices (such as screens 1010 to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system 1000 can also include human accessible storage devices and their associated media such as optical media including CD/DVD ROM/RW 1020 with CD/DVD 1011 or the like media, thumb-drive 1022, removable hard drive or solid state drive 1023, legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system 1000 can also include interface 1099 to one or more communication networks 1098. Networks 1098 can for example be wireless, wireline, optical. Networks 1098 can further be local, wide-area, metropolitan, vehicular and industrial, real-time, delay-tolerant, and so on. Examples of networks 1098 include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks 1098 commonly require external network interface adapters that attached to certain general-purpose data ports or peripheral buses (1050 and 1051) (such as, for example USB ports of the computer system 1000; others are commonly integrated into the core of the computer system 1000 by attachment to a system bus as described below (for example Ethernet interface into a PC computer system or cellular network interface into a smartphone computer system). Using any of these networks 1098, computer system 1000 can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core 1040 of the computer system 1000.

The core 1040 can include one or more Central Processing Units (CPU) 1041, Graphics Processing Units (GPU) 1042, a graphics adapter 1017, specialized programmable processing units in the form of Field Programmable Gate Areas (FPGA) 1043, hardware accelerators for certain tasks 1044, and so forth. These devices, along with Read-only memory (ROM) 1045, Random-access memory 1046, internal mass storage such as internal non-user accessible hard drives, SSDs, and the like 1047, may be connected through a system bus 1048. In some computer systems, the system bus 1048 can be accessible in the form of one or more physical plugs to enable extensions by additional CPUs, GPU, and the like. The peripheral devices can be attached either directly to the core's system bus 1048, or through a peripheral bus 1051. Architectures for a peripheral bus include PCI, USB, and the like.

CPUs 1041, GPUs 1042, FPGAs 1043, and accelerators 1044 can execute certain instructions that, in combination, can make up the aforementioned computer code. That computer code can be stored in ROM 1045 or RAM 1046. Transitional data can be also be stored in RAM 1046, whereas permanent data can be stored for example, in the internal mass storage 1047. Fast storage and retrieval to any of the memory devices can be enabled through the use of cache memory, that can be closely associated with one or more CPU 1041, GPU 1042, mass storage 1047, ROM 1045, RAM 1046, and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, an architecture corresponding to computer system 1000, and specifically the core 1040 can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core 1040 that are of non-transitory nature, such as core-internal mass storage 1047 or ROM 1045. The software implementing various embodiments of the present disclosure can be stored in such devices and executed by core 1040. A computer-readable medium can include one or more memory devices or chips, according to particular needs. The software can cause the core 1040 and specifically the processors therein (including CPU, GPU, FPGA, and the like) to execute particular processes or particular parts of particular processes described herein, including defining data structures stored in RAM 1046 and modifying such data structures according to the processes defined by the software. In addition or as an alternative, the computer system can provide functionality as a result of logic hardwired or otherwise embodied in a circuit (for example: accelerator 1044), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed is:

1. A method for provisioning services for a 5G media streaming, the method being executed by at least one processor, the method comprising:
receiving a first service provisioning session request for devices of a first release;
controlling a 5GMS Application Server to allocate resources for the requested first service provisioning session;
receiving a second service provisioning session request for devices of a second release;
controlling the 5GMS Application Server to determine whether the allocated resources for the requested first service provisioning session are adequate for the requested second service provisioning session; and
in response to determining that the allocated resources for the requested first service provisioning session are not adequate for the requested second service provisioning session, controlling the 5GMS Application Server to allocate resources for the requested second service provisioning session.

2. The method of claim 1, wherein prior to the receiving the first service provisioning session request for the devices of the first release, the method comprises:
receiving a first provisioning request for the devices of the first release, the first provisioning request comprising one or more lower-level releases for copied provisioning;
controlling a 5GMS Application Function to provision for the devices of the first release; and
controlling the 5GMS Application Function to create directories and copy resources for the one or more lower-level releases.

3. The method of claim 1, wherein the second service provisioning session request comprises a provision session identifier of the requested first service provisioning session.

4. The method of claim 1, wherein the method further comprises:
in response to determination that the allocated resources for the requested first service provisioning session are adequate for the requested second service provisioning session, controlling the 5GMS Application Server to re-allocate resources allocated for the requested first service provisioning session.

5. The method of claim 1, wherein the first release is a highest release and the second release is a lower-level release of the first release.

6. An apparatus for media streaming, the apparatus comprising:
at least one memory configured to store program code; and
at least one processor configured to access the program code and operate as instructed by the program code, the program code comprising:
controlling code configured to cause the at least one processor to control a 5GMS network device to provision resources using service access information, wherein:
the service access information comprising a plurality of sub-resources, and
the service access information comprises a change flag is associated with each of the plurality of sub-resources,
the change flag indicates that a respective sub-resource associated with the change flag has been changed or is new, and
when one or more change flags are set to true, the service access information further comprises one or more additional data structures for one or more sub-resources associated with the one or more change flags.

7. The apparatus of claim 6, wherein when the 5GMS network device provisions resources using the service access information for a first time, every change flag in the service access information is set to true, and the service access information comprises first data structures for the plurality of sub-resources.

8. The apparatus of claim 6, wherein when the 5GMS network device is controlled to add a new sub-resource to the service access information, the change flag associated with the new sub-resource is set to true and an additional data structure associated with the new sub-resource is added to the service access information.

9. The apparatus of claim 8, wherein when the 5GMS network device is controlled to add the new sub-resource to the service access information, change flags associated with each of the plurality of sub-resources are set to false.

10. The apparatus of claim 6, wherein when the 5GMS network device is controlled to remove a first sub-resource from the service access information, the change flag associated with the first sub-resource is set to true and a data structure associated with the first sub-resource is removed from the service access information.

11. The apparatus of claim 10, wherein when the 5GMS network device is controlled to remove the first sub-resource from the service access information, change flags associated with each of the plurality of sub-resources that are not the first sub-resource are set to false.

12. The apparatus of claim 6, wherein when the 5GMS network device is controlled to update a first sub-resource from the service access information, the change flag associated with the first sub-resource is set to true and a data structure associated with the first sub-resource is updated in the service access information.

13. The apparatus of claim 12, wherein when the 5GMS network device is controlled to update the first sub-resource from the service access information, change flags associated with each of the plurality of sub-resources that are not the first sub-resource are set to false.

14. A non-transitory computer readable medium storing a program, that when executed by at least one processor, causing the at least one processor to execute:
control a 5GMS network device to provision resources using service access information, wherein:
the service access information comprising a plurality of sub-resources, and
the service access information comprises a change attribute is associated with each of the plurality of sub-resources,
the change attribute indicates whether a respective sub-resource associated with the change attribute has been created, updated, destroyed, or not changed, and
when one or more change attributes indicate that one or more sub-resources are created or updated, the service access information further comprises one or more additional data structures for the one or more sub-resources associated with the one or more change attributes.

15. The non-transitory computer readable medium of claim 14, wherein when the 5GMS network device provisions resources using the service access information for a first time, every change attribute in the service access information is set to create, and the service access information comprises first data structures for the plurality of sub-resources.

16. The non-transitory computer readable medium of claim 14, wherein when the 5GMS network device is controlled to add a new sub-resource to the service access information, the change attribute associated with the new sub-resource is set to create and an additional data structure associated with the new sub-resource is added to the service access information.

17. The non-transitory computer readable medium of claim 16, wherein when the 5GMS network device is controlled to add the new sub-resource to the service access information, change attributes associated with each of the plurality of sub-resources are set to no change.

18. The non-transitory computer readable medium of claim 14, wherein when the 5GMS network device is controlled to remove a first sub-resource from the service access information, the change attribute associated with the first sub-resource is set to destroy and a data structure associated with the first sub-resource is removed from the service access information; and
change attributes associated with each of the plurality of sub-resources that are not the first sub-resource are set to no change.

19. The non-transitory computer readable medium of claim 14, wherein when the 5GMS network device is controlled to update a first sub-resource from the service access information, the change attribute associated with the first sub-resource is set to update and a data structure associated with the first sub-resource is updated in the service access information.

20. The non-transitory computer readable medium of claim 19, wherein when the 5GMS network device is controlled to update the first sub-resource from the service access information, change attributes associated with each of the plurality of sub-resources that are not the first sub-resource are set to no change.
